(19) United States
(12) Patent Application Publication
(10) Pub. No.: US 2014/0321974 A1
(43) Pub. Date: Oct. 30, 2014

(54) WIND TURBINE SYSTEM

(71) Applicant: NEW WORLD ENERGY ENTERPRISES LTD, Longford (IE)

(72) Inventors: James SMYTH, County Cavan (IE); Peter SMYTH, County Longford (IE); David SMYTH, County Longford (IE); Gerard SMYTH, County Longford (IE); Andrew SMYTH, County Armagh (IE)

(73) Assignee: NEW WORLD ENERGY ENTERPRISES LTD, Longford (IE)

(21) Appl. No.: 13/888,790

(22) Filed: May 7, 2013

(30) Foreign Application Priority Data
Apr. 30, 2013 (GB) 1307782.1

(51) Int. Cl. F21S 9/04

(52) U.S. Cl. CPC F21S 9/043
USPC 415/4.3; 415/121.3

(57) ABSTRACT

A wind turbine system having a street light having an upright support or post on which is mounted a canopy housing any suitable lighting gear, and a wind turbine mounted above the canopy and operable to generate electrical energy with which to power the light, the canopy being adapted to augment the flow of air through the wind turbine.

### REFERENCE TO RELATED APPLICATION

This application claims priority to U.K. Patent Application No. 1307782.1, filed Apr. 30, 2013, the disclosure of which is incorporated herein by reference.

### FIELD OF THE INVENTION

This invention relates to a wind turbine system, and in particular a wind turbine system which includes a wind turbine mounted above a relatively conventional streetlight, and which may then be used to provide electrical power to the streetlight, whilst at the same time the streetlight can be used to augment the flow of air through the turbine in order to improve the performance thereof.

### BACKGROUND OF THE INVENTION

Street lighting is a ubiquitous aspect of modern life, in both urban and rural environments, and in many instances is an essential component of the physical fabric of society. Estimates put the number of street lights globally at approximately one billion. It will therefore be appreciated that, at a global level, and indeed at national and local levels, street lighting consumes a vast amount of electrical energy, and thus has a significant impact on our environment, for reasons which are well documented.

It is therefore an object of the present invention to reduce or eliminate the non renewable consumption of power by street lighting, in particular by combining a wind turbine with a street light in order to provide power thereto.

### SUMMARY OF THE INVENTION

According to the present invention there is provided a wind turbine system comprising a street light having a post and a canopy mounted adjacent an upper end of the post; a turbine comprising a shroud mounted above the canopy, and a set of turbine blades housed for rotation within the shroud; wherein the canopy is adapted to augment the flow of air through the shroud.

Preferably, the canopy defines a reflector enclosing one or more light sources.

Preferably, the canopy is substantially dome shaped comprising a curved upper surface which augments the flow of air through the shroud.

Preferably, the shroud is rotatably mounted above the canopy in order to be capable of tracking the direction of the prevailing wind.

Preferably, the turbine system comprises a tracking assembly adapted to operatively align the shroud with the prevailing wind.

Preferably, the tracking assembly comprises at least one vane adapted to operatively align the shroud with the prevailing wind.

Preferably, the turbine system comprises one or more solar panels.

Preferably, the one or more of the solar panels are disposed on an upper surface of the canopy.

Preferably, the turbine system comprises one or more batteries chargeable by the turbine and/or the solar panels and operable to supply the streetlight with power.

Preferably, the one or more batteries are housed within the canopy.

Preferably, the post comprises at least two sections hingedly connected to one another.

Preferably, the post extends beyond the canopy and forms a support for the shroud and the turbine blades.

Preferably, the shroud defines a substantially convergent divergent cross section.

Preferably, the shroud comprises a mouth defining an air inlet, the mouth being at least partially disposed downstream of a radial extremity of the canopy.

Preferably, the canopy and the shroud each have a complementary curvature at a region of transition from the canopy to the shroud.

Various other objects, advantages and features of the present invention will become readily apparent to those of ordinary skill in the art, and the novel features will be particularly pointed out in the appended claims.

### BRIEF DESCRIPTION OF THE DRAWINGS

The present invention will now be described with reference to the accompanying drawings, in which;

FIG. 1 illustrates a perspective view of a wind turbine system according to an embodiment of the present invention;

FIG. 2 illustrates a perspective view of the wind turbine system of FIG. 1, showing an underside of a light canopy forming part of the system; and

FIG. 3 illustrates a side elevation of the wind turbine system shown in FIGS. 1 and 2.

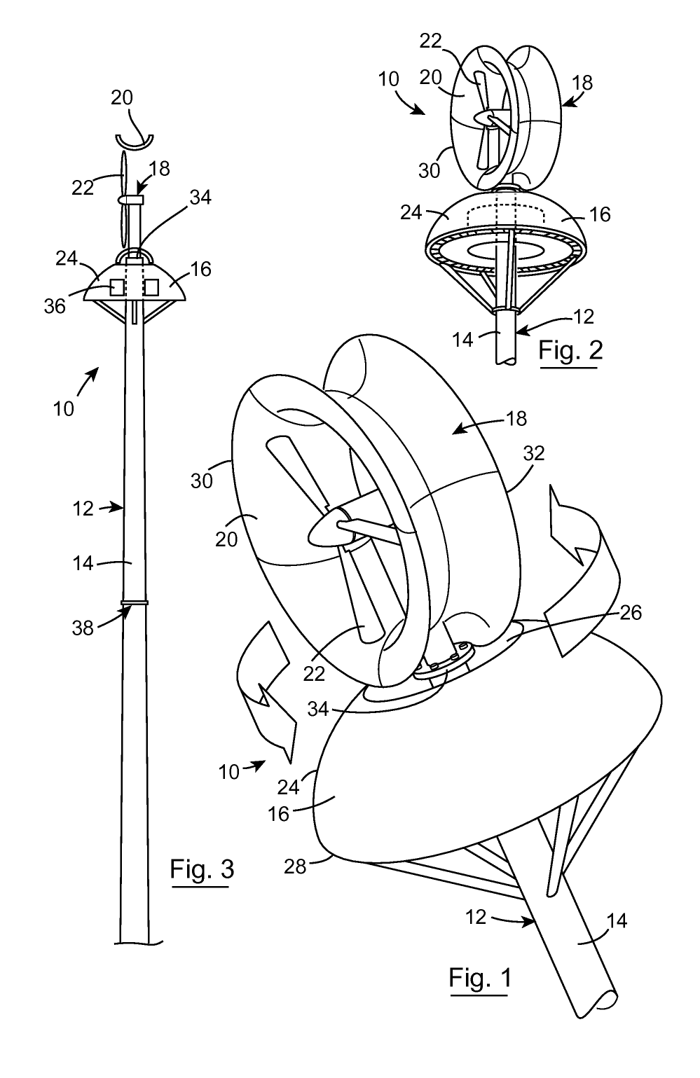

### DETAILED DESCRIPTION OF THE DRAWINGS

Referring now to the accompanying drawings there is illustrated a wind turbine system, generally indicated as 10, for use in supplying renewable electrical energy to a street light in order to allow the street to be operated without grid supplied electrical energy, or even without a grid connection if desired.

The wind turbine system 10 comprises a substantially conventional street light 12 which comprises an upright and elongate post 14 mounted adjacent an upper end of which is a lighting canopy 16. As used herein, the term “post” is intended to cover any support on which is mounted a street light, regardless of whether the support is an elongate pole type support or any other suitable alternative, which post may vary considerably is size and shape depending on the location and/or other factors.

Combined with the street light 12 is a wind turbine 18 which is comprised of a horizontal axis shroud 20 mounted within which are a set of turbine blades 22 which undergo rotation in response to the flow of air through the shroud 20, in order to generate electricity. In addition to providing power directly to the street light 12, the combined street light 12 and wind turbine 18 have a synergistic relationship whereby the street light 12, and in particular the canopy 16, is utilized in order to augment the flow of the air through the turbine 18, thereby increasing the performance thereof.

The post 14 may be of any suitable dimensions, and formed from any suitable material, once capable of supporting the canopy 16 and turbine 18 thereon, which in the embodiment illustrated are mounted towards an upper end which of the canopy 16 but which could conceivably be mounted at some other position depending on the particular requirements or environment in which the system 10 is installed. The canopy 16 encloses one or more light sources (not shown), which may for example be sodium pressure bulbs, metal halide bulbs, LED's, or any other suitable light source. An interior surface of the canopy 16 preferably defines a reflector (not shown) to direct and focus the light downwardly towards the ground and surrounding area or in any other desired direction.

An upper surface 24 of the canopy 16 is substantially dome shaped, but may have a flattened top 26 in order to accommodate the shroud 20 as hereinafter described. It will also be understood that the canopy 16 may be of any other shape or configuration as required.

The curved or domed profile of the upper surface 24 serves to augment the flow of air into the shroud 20, primarily by increasing the volume of air flow into the shroud 20. The upper surface 24 curves upwardly and rearwardly from an outer rim 28 towards the top 26. This curvature forces air flowing past the canopy 16 upwardly towards and into the shroud 20. A mouth 30 defining an inlet to the shroud 20 is thus located downstream of the outer rim 28, in order to receive this redirected air flow. The shroud 20 is preferably positioned relative to the canopy 16 such that the bottom dead centre of the mouth 30 is directly adjacent the upper surface 24, with the minimum gap possible preferably being provided between the shroud 20 and the canopy 16 in order to minimize leakage of the redirected air between the canopy 16 and shroud 20.

The shroud 20 of the embodiment illustrated, and as can be seen from FIG. 3, is of a substantially convergent divergent cross section tapering inwardly from the mouth 30 towards a throat of the shroud 20, before tapering back outwardly towards an exhaust 32. The curvature of the upper surface 24 of the canopy 16, directly upstream of the mouth 30, and the curvature of the inner surface of the shroud 20 in the region of the mouth 30, are preferably complementary in order to provide a smooth transition for the air flow from the canopy 16 into the shroud 20, thereby minimizing turbulence and boundary layer separation.

In the embodiment illustrated the post 14 extends upwardly beyond the canopy 16 such as to provide a mount and support for the shroud 20 and the blades 22, again as can be clearly seen in FIG. 3. A bearing 34 preferably separates the post 14 at the intersection between the canopy 16 and shroud 20. This bearing 34 thus allows the turbine 18 to rotate on the post 14 in order to track the prevailing winds. In this way the turbine 14 will always be facing into the wind in order to generate the maximum amount of electricity.

The system 10 may be provided with a tracking assembly (not shown) in order to operatively align the shroud 20 with the prevailing wind. In a preferred embodiment the tracking assembly may comprise at least one vane (not shown) mounted in a trailing configuration to the shroud 20 in order to ensure that the shroud 20, in particular a horizontal axis thereof about which the blades 22 rotate, is aligned with the direction of the prevailing wind.

In use the turbine 18 generates electrical energy through rotation of the blades 22 in response to the flow of air through the shroud 20. This electrical energy may be utilized as required, for example to power the street light 12 or alternatively to be fed back into the grid for alternative applications, or a combination of both of the above. When utilized to power the street light 12, it is preferable that the system 10 comprises one or more batteries 36, which in the embodiment illustrated are housed within the canopy 16, and which are charged with electrical energy generated by the turbine 18.

The turbine 18 may be supplemented by providing the system 10 with one or more solar panels (not shown) whose electrical energy can then be stored in the one or more batteries 36 to again power the street light 12, or may be fed back into the grid. The solar panels (not shown) may be positioned at any suitable location, for example on the upper surface of the canopy 16 or elsewhere, and could for example take the form of solar tape applied to the canopy 16.

In this way electrical energy generated during day light hours, or when the light 12 is not being operated, can be stored in the batteries 36, and can then be utilised at night or as required in order to provide electrical power to the street light 12. Suitable control circuitry (not shown) may be provided in order to affect this control action.

In order to allow servicing, repair or replacement/removal of both the turbine 18 and the canopy 16 and related lighting gear, the post 14 is preferably provided with a hinge 38 disposed at a position between the base of the post 14 and the canopy 16, for example half way along the post 14. By opening the hinge the upper half of the system 10 can then be hinged downwardly about the lower portion of the post 14, thus bringing the turbine 18 and canopy 16 to ground level for the above mentioned servicing, repair or replacement.

The wind turbine 18, or the combined wind turbine 18 and canopy 16, may be readily retrofitted to existing street lights.

It will thus be appreciated that the present invention provides a simple yet effective means of providing stand alone power to a street light 12 when simultaneously providing a synergistic improvement to the operation of the turbine 18 powering the street light 12.

The present invention is not limited to the embodiments described herein, which may be amended or modified without departing from the scope of the present invention.

Therefore, it is intended that the appended claims be interpreted as including the embodiments described herein, the alternatives mentioned above, and all equivalents thereto.

What is claimed is:

1. A wind turbine system, comprising:
a street light having a post and a canopy mounted adjacent an upper end of the post;
a turbine comprising a shroud mounted above the canopy; and
a set of turbine blades housed for rotation within the shroud;
wherein the canopy is adapted to augment the flow of air through the shroud.

2. A wind turbine system according to claim 1 in which the canopy defines a reflector enclosing one or more light sources.

3. A wind turbine system according to claim 1 in which the canopy is substantially dome shaped comprising a curved upper surface which augments the flow of air through the shroud.

4. A wind turbine system according to claim 1 in which the shroud is rotatably mounted above the canopy in order to be capable of tracking the direction of the prevailing wind.

5. A wind turbine system according to claim 4 comprising a tracking assembly adapted to operatively align the shroud with the prevailing wind.

6. A wind turbine system according to claim 5 in which the tracking assembly comprises at least one vane adapted to operatively align the shroud with the prevailing wind.

7. A wind turbine system according to claim 1 comprising one or more solar panels.

8. A wind turbine system according to claim 7 in which the one or more of the solar panels are disposed on an upper surface of the canopy.

9. A wind turbine system according to claim 1 comprising one or more batteries chargeable by the turbine and/or solar panels and operable to supply the streetlight with power.

10. A wind turbine system according to claim 9 in which the one or more batteries are housed within the canopy.

11. A wind turbine system according to claim 1 in which the post comprises at least two sections hingedly connected to one another.

12. A wind turbine system according to claim 1 in which the post extends beyond the canopy and forms a support for the shroud and the turbine blades.

13. A wind turbine system according to claim 1 in which the shroud defines a substantially convergent divergent cross section.

14. A wind turbine system according to claim 1 in which the shroud comprises a mouth defining an air inlet, the mouth being at least partially disposed downstream of a radial extremity of the canopy.

15. A wind turbine system according to claim 1 in which the canopy and the shroud each have a complementary curvature at a region of transition from the canopy to the shroud.
